(19) United States
(12) Patent Application Publication
(10) Pub. No.: US 2008/0166111 A1
(43) Pub. Date: Jul. 10, 2008

(54) Back Light Screen for Chroma-Key Photography

(76) Inventors: Richard Didow, Tomball, TX (US); Robert Bryant, Houston, TX (US)

Correspondence Address: LAW OFFICE OF DAVID MCEWING, P.O. BOX 231324, HOUSTON, TX, 77023, US

(21) Appl. No.: 12/054,873

(22) Filed: Mar. 25, 2008

Related U.S. Application Data
(63) Continuation-in-part of application No. 11/002,532, filed on Dec. 1, 2004.

(51) Int. Cl. G03B 15/00

(52) U.S. Cl. 396/3

(57) ABSTRACT

A chromo-key screen method and device having a first chroma-key screen component with a front surface and a back surface and screen enclosure wherein the screen enclosure is capable of reflecting light from a back enclosure screen to the back surface of the chroma-key screen and transmitted to the front surface of the chroma-key screen component. Further, one or more lights or other electromagnetic energy generators transmit energy onto the back screen that is reflected to the chroma-key screen component and transfused to the front surface of the chroma-key screen and transmitted from the front surface into area subject of an image capturing device, e.g. photographic or digital camera. The invention applies to chroma-key photography wherein the background screen is lighted, at least in part, from a source behind the screen. The device may include an enclosure to restrict color spilling into the foreground. The enclosure can comprise a top and two sides, in addition to the back screen and the chroma-key or green screen.

### RELATED APPLICATION

This application is a continuation in part of application Ser. No. 11/002,532, filed Dec. 1, 2004 and entitled “Back Light Screen for Chroma-Key Photography” and which is hereby incorporated by reference herein.

### BACKGROUND OF THE INVENTION

1. Field of Use

This invention relates to a light enclosing background screen structure in color difference image composite photography or “chroma-key” still or motion photography. Light transfuses through the first front screen. The enclosure contains lights that are direct to the back, side, or top screens for the diffusion of the light. The invention may be used with traditional silver halide photographic imagery or with electronic digital photography. The invention also relates to a method of lighting a background screen to minimize shadows and to compress the space between the foreground photo subject and the first front (chroma-key) screen.

2. Related Art

Chroma-key and “color difference”, “green screen” or “blue screen” photography are known. One limitation has been the difficulty of removing or subtracting of the background or background color from the foreground image when the background is non-uniform. The variation of the front screen may be caused by uneven lighting or shadows. Another problem has been “color spilling”. Another limitation has been the amount of space and cost of lighting required to achieve a sufficiently uniform background or maintain the background due to movement of the photo subjects or changes in other light sources. Several methods or devices have been used in efforts to overcome these limitations. For example U.S. Pat. Nos. 5,897,413 and 6,211,941 (Erland) teach use of a bi-axially stretchable fabric of synthetic fibers treated with a dye. The technique utilizes the photochemical properties of light to actinically energize the treated fibers for improved illumination of the background screen surface. Other methods have attempted to alter the placement of lights or light reflective surfaces.

U.S. Pat. No. 6,674,485 (Akiyama) assigned to Hitachi Software Engineering Inc., describes the chroma-keying as an image compositing method wherein a picture is taken of a subject, composting a foreground (subject) image of the picture with a background image and printing out the combined or composite image. The method comprises the steps of: extracting the foreground image from the background; memorizing saturation, brightness and hue distribution of the background image; and correcting saturation, brightness and hue distribution of the foreground image with respect to the saturation, brightness and hue distribution of the background image.

Further chromo-keying requires a blue or green screen (or other color screen as will be appreciated by persons skilled in the art) behind the foreground (photo subject) that is substantially uniform, featureless and without shadow. This requires a number of multi-directional light sources behind the subject to prevent the shadow of the subject from casting on the background screen. Accordingly chroma-keying requires considerable cost and sufficiently large space to practice due to the exacting lighting requirements needed to maintain a uniform and featureless background behind the photo subject. This has limited the applicability or utility of the method.

Frequently, the background is a colored screen is made from a woven fabric. This is an ideal material due to it being lightweight, foldable and having the ability to be cut in a variety of sizes and shapes. It also provides a good support or substrate for color coating, printing or paintings. The Hitachi invention utilizes a small and rigid LED type lighted screen behind the photo subject while the subject stands or sits in a small booth like compartment that is shielded from outside light sources. The background screen is therefore limited in size and shape and is not collapsible or lightweight.

### SUMMARY OF INVENTION

The method and device subject of the present invention includes a first chromo-key screen with a front surface and a back surface. The specification also discloses a light enclosing screen structure supported by a frame. The structure comprises a second back screen, two side screens (connecting the first front screen and second back screen) and a top screen. The lights may be mounted on the frame and be directed to the second back screen or side screens to reflect and diffuse the light to the first translucent chroma-key front screen. The other screens of the enclosure structure are not translucent and may be closely attached to the frame with hook and loop attachment mechanisms or similar devices. Light is emitted from the first front screen in a flat, featureless manner. The light will have a distinctive color such as blue or green. The invention applies to chroma-key photography wherein the chroma-key screen is lighted, at least in part, from a source behind the screen.

### SUMMARY OF DRAWINGS

The accompanying drawings, which are incorporated in and constitute a part of the specification, illustrate preferred embodiments of the invention. These drawings, together with the general description of the invention given above and the detailed description of the preferred embodiments given below, serve to explain the principles of the invention.

FIG. 1 illustrates a perspective view of the preferred embodiment of the invention wherein the lighting source is contained within an enclosed structure and the lighting is directed to a reflective back screen.

FIG. 2A illustrates a cross sectional view wherein there is no enclosure and there is color spilling on the foreground subject.

FIG. 2B illustrates the a cross sectional view of the illustration of FIG. 1 with the minimization of color spilling as taught by an embodiment of the present invention.

FIG. 3 illustrates the first screen material (chroma-key screen) in relation to the light source, the transmission of light on to the back surface of the chroma-key screen, the transfusion or diffusion of light through the screen material and the transmission of light from the front surface of the chroma-key screen into the foreground.

FIG. 4 illustrates the prior art relationship of the photo subject, foreground, lighting and chroma-key screen.

FIG. 5 illustrates the relationship of the photo subject, foreground, lighting, chroma-key screen and background enclosure as taught by the present invention.

FIG. 6 illustrates the assembly of support or frame components for the enclosure structure.

FIGS. 7A, 7B, 7C, 7D, 7E illustrate the relationship and possible sequential installation of the support components and the light enclosure structure components.

### DETAILED DESCRIPTION OF THE INVENTION

The above general description and the following detailed description are merely illustrative of the subject invention and additional modes, advantages and particulars of this invention will be readily suggested to those skilled in the art without departing from the spirit and scope of the invention.

Chroma-key photography includes the step of distinguishing the background from the foreground, typically by use of differing colors. The step often utilizes a strong vibrant colored background, e.g. a blue or green color screen. At some point, the distinct color difference between the flat, featureless screen (hereinafter “green screen” or “chroma-key screen”) and the foreground object is used to remove or separate the foreground from the background. In one variation, the color components of the green screen are removed from the entire photo image. Since the foreground contains little of the background color component (absent color spillage), there is little or no loss in the foreground image. In digital photography, the separation of background from foreground can be accomplished by subtracting the value of background color from each pixel of the image. This can be accomplished by several methods, including computer software. It will be appreciated that the “green screen” may be any color, including but not limited to blue.

It is a general object of this invention to provide an enclosure structure that can be used in color difference or chroma-key photography (hereinafter “chroma-key”). Specifically, the structure uniformly disburses light. The structure comprises a first back-lighted or rear lighted surface that provides or displays a substantially uniform background color that can be distinguished and subtracted out of the photo image. Frequently, the background is replaced with a separate image thereby achieving a composite photo.

The present invention combines the flexibility and portability of flexible background material, including but not limited to woven fabric with other materials and components to reduce the space and lighting requirements for uniform lighting of the background, reduction of color spilling and avoidance of optical illusions or Moire effect (hereinafter “noise pattern”).

It will be appreciated that the photo subject is positioned in front, i.e., foreground, of a back-lighted green screen, such back-lighted surface displaying a uniform colored background, the color components of which are recognizable and can be removed from the image without unsatisfactory degradation of the foreground image. The recognition and removal of the background color can be performed by CPU controlled software and equipment.

In an embodiment of the invention, the chroma-key screen includes a non woven material such as a foam or other material that does not contain a repetitive grid or parallel line pattern (such as the line patterns created by a fabric weave and possible pattern of light refraction) and through which light can be transmitted or transfused. Light passing through the screen does therefore not create a Moire effect or noise pattern seen by the image capturing device or camera. A light source can be placed behind the screen. The chroma-key screen allows the foreground subject or photo subject to be positioned closer to the first screen. The foreground subject can therefore be the principal object, e.g., light quantity and quality, of the lighting in front of the chroma-key screen. Concern with shadow can be reduced since the background is now providing its own light source. Further, the light sources are separately positioned and directed rearward to reflect the light off the second back enclosure screen, the top screen and side screens, thereby further dispersing the light. In other embodiments, there can be a translucent and light-diffusing coating placed on a woven (or non woven) fabric. The first screen may contain a coating or covering sub-component that may contain actinic properties. The first screen may also be translucent. The lights may also contain a coating.

Prior to the subject invention, the photo object was required to be approximately 5 to 6 feet in front of the background screen. In the present invention, the photo subject can be approximately 1 foot in front of the screen. Since the lighted area is thereby significantly reduced, there is a resulting increase efficiency of space and energy.

In the preferred embodiment of the present invention, the green screen (chroma-key screen) is configured as an outer surface of a substantially enclosed structure. The structure is enclosed with a second back screen, two side screens and a top screen. The structure includes a frame. The structure includes the light mechanism or source directed to the rear of the enclosure for diffusion of light to the back of the translucent green screen. The lighting source within the enclosure can enhance the efficiency of light energy shining upon or directed (“transmitted”) to the back enclosure screen or to the side screen or top screen. The light is reflected onto the green screen. As will be appreciated by persons skilled in the art, a portion of the light is transfused or conveyed through the green screen (chroma-key screen) to the foreground. The other surfaces (screens) of the structure can be reflective, thus allowing light to be transmitted to the green screen surface multiple times. The screen may be of either a transparent or translucent material. The second back screen and side and top screens can be coated with a component that colors or tints the light. There may be a similar coating on the first background screen. The coating may be on either or both sides of the first screen. A portion of the light is then transmitted out from the front surface of the first screen (which may be a coated diffusing or coloring surface) into the foreground area where the photo subject may be located. Tinting the light transmitted through the first screen can enhance the subtraction of the color by the computer.

As will be appreciated by persons skilled in the art, the chroma-key screen material can be selected from translucent material, i.e., allowing the penetration of light through the material while sufficiently diffusing the transfused light so that no image from the back of the screen is visible. The back screen, side screens and top screens are not translucent.

The screen material of the chroma-key screen may contain color absorptive components such that the light energy transmitted from the front surface into the foreground is a suitable or selected range of wavelengths. Although a woven fabric has often been used as a screen material, efforts to provide backlighting through the woven fabric have had undesired results. Transmitting light through the back of a fabric screen has not satisfactorily reduced color spilling. It has also has created undesired “noise” or non uniformity in the background seen by the camera. It is likely that light transmitted through the woven fibers creates a Moire effect, i.e., an optical illusion that occurs when many parallel lines are placed near each other or there is a repetitive grid pattern within the material. Such repetitive grid may be created by the fiber weave pattern of the woven fabric.

It will be further appreciated that the energy may be of other electromagnetic energy outside the visible light spectrum. It will also be appreciated that varying the wavelength of an energy source may alter the refraction of the energy through the material.

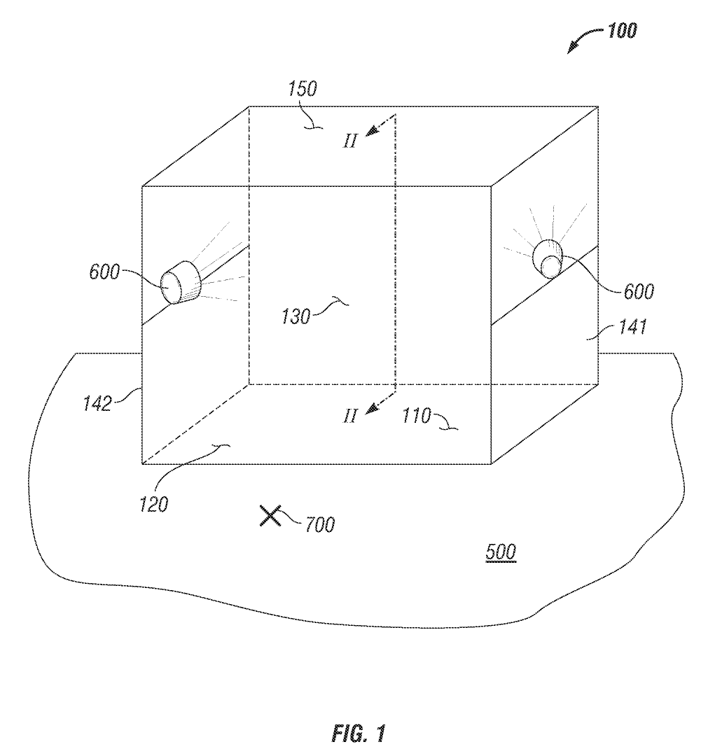

FIG. 1 illustrates a perspective view of a simple example of a “six-sided” structure 100 of a preferred embodiment, containing a chroma-key screen or green screen surface 110. Another side 120 may comprise the floor surface 500. The structure may have a back-screen 130, two side panel screens 141, 142 and a top screen 150. It will be appreciated that the surface of the chroma-key screen 110 within the interior of the rectangular structure 100 comprises the back side of the chromo-keyed screen viewed by the camera. The large “X” 700 shown on the floor surface 500 approximates the fore ground in front of the back lighted or chromo-keyed screen. Also illustrated within the structure are 2 lights 600 that shine light upon the second back screen 130. It will be appreciated that the invention is not limited to the number, type or configuration of the light sources. For example, and not by way of limitation, there can be 4 or six lights within the enclosure.

The invention in further not limited to the use of an enclosed structure. The screen is also not required to be a planar surface and may be a concave or other complex shape. Such complex shape may enhance the 3 dimensional effect of the final composite chroma-key image.

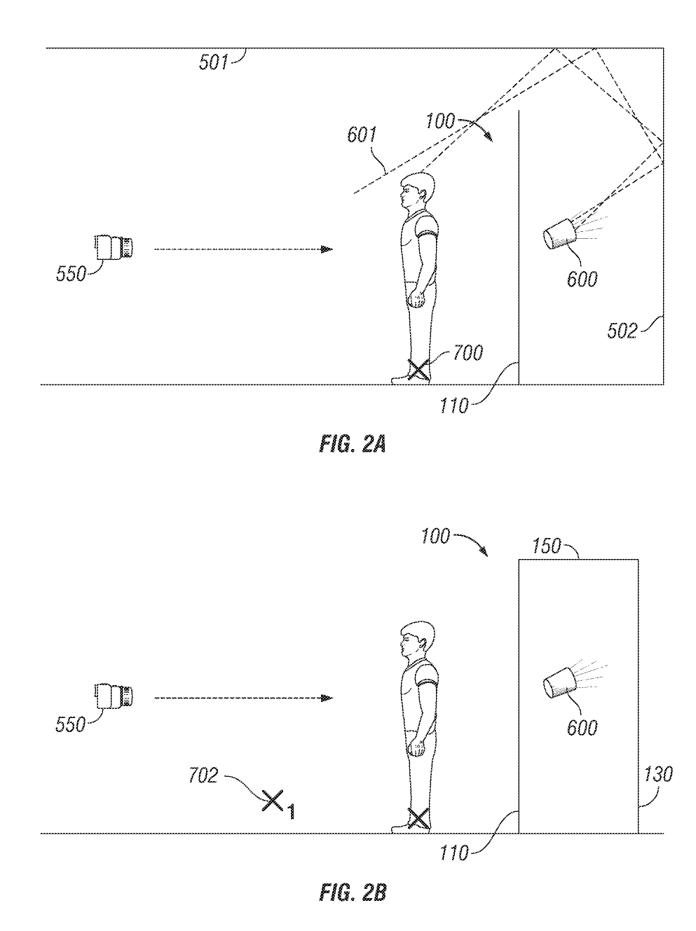

FIG. 2B illustrates a cross sectional view of the enclosure screen structure 100 along the axis II illustrated in FIG. 1. Illustrated are the lighting devices 600 within the enclosure 100, an enclosure top 150, second enclosure back 130, the floor 500 forming the bottom 120. Also illustrated is the chroma-key screen 110. It will be appreciated that the chroma-key screen 110 is the front side of the enclosure 100 relative to the foreground area illustrated by the “X” 700. A photo subject 701 is illustrated standing in the foreground 700, between the camera 550 (or other image capturing device) and the chroma-key screen 110.

It will be appreciated that the use of the enclosure structure illustrated in FIGS. 1 and 2B will limit the amount of light or color “spilling” into the foreground from the back screen lighting structure. It will be appreciated that the lighting devices may emit a selected color or contain a portion of the color spectrum that is to be subtracted from the photo image and which may be spilling onto the photo subject in the foreground. The lighting devices may containing a coating that tint the emitted light. It will be appreciated that it is desired that the uniform, featureless screen is to be of a color that is not a significant component of the photo subject. Therefore, it is undesirable for the light from the screen lighting (or other electromagnetic energy) to spill on to the photo subject, i.e., color spilling.

The undesired spilling light is illustrated by comparison of FIGS. 2A and 2B. In FIG. 2A, light 601 from light sources 600 is transmitted to the back of the screen and transfused through the screen into the foreground. However a portion of the light is reflected from other surfaces such as a ceiling 501 and walls 502, thereby causing portion of light to by pass the screen 110 and spill onto the photo subject 701 standing in the foreground X 700 and beyond X₁ 702. This additional light will be seen by the image capturing device 550, e.g., the camera, on the image of the foreground subject 701. It will be appreciated that X₁ is the approximate foreground utilized in the prior art methodology without backlighting of the chroma-key screen.

In contrast, FIG. 2B illustrates the light 601 emitted from the light sources 600 remaining within the structure 100, except the portion reflected from the inside surface of the top 150, side (not shown) and second back screen 130 and transmitted onto the back surface of the first background screen 110 and transfused through and transmitted 603 into the foreground X 700. The transmitted light 603 does not spill onto the photo subject 701. The light is more efficiently used. The background color components can also be more effectively removed from photo without impacting the image in the foreground. The interior surfaces of the top 150, back 130, sides (not shown) and bottom 120 maybe light reflective.

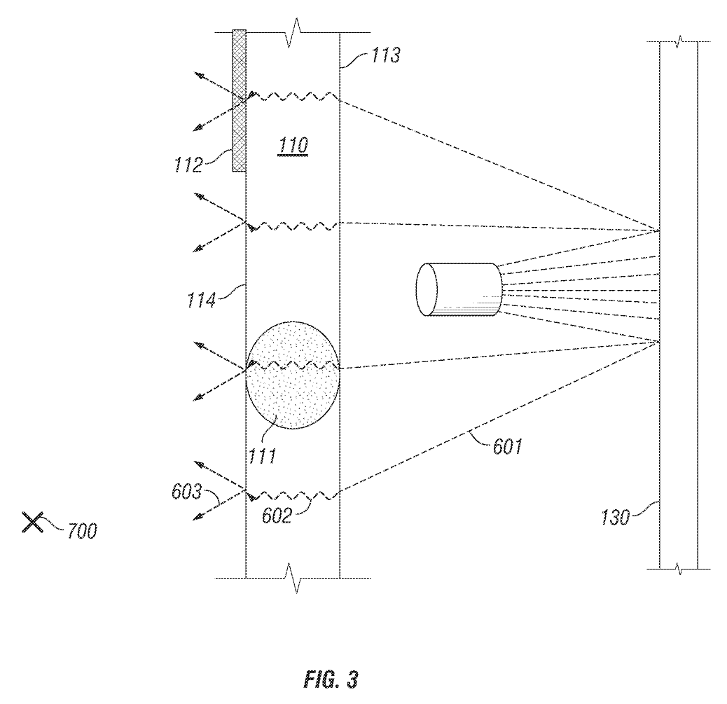

FIG. 3 illustrates an expanded cross sectional view of the chroma-key screen material 110, having a front surface 114 and back surface 113. The light source 600 and foreground 700 are also illustrated. The light 601 (or other electromagnetic energy) is transmitted or radiated from the light source 600 and reflect from the back screen enclosure 130 to the back surface 113 of the chroma-key screen 110 material. At least some portion of the light 602 (or other electromagnetic energy) is diffused or transfused through the chroma-key screen material to the front surface 114 where again, at least some portion 603 is transmitted into the foreground 700. In one embodiment, the material of the chroma-key screen may contain a component 111 or 112 that absorbs all colors other than that portion of the color spectrum to be transmitted into the foreground. This function may be performed by a coating 112 on either the front surface 114 or back surface of the screen material. The coating may be on both sides and be used with an absorptive component 111 within the material. Alternatively, the coating or component may reflect all portions of the color spectrum except the desired portion to be transmitted into the foreground.

In another embodiment of the invention, the screen material may contain a coating of a dye formulation including fluorescence which is photo-chemically reactive (actinic) to an energy source such as a spectra of electromagnetic radiation, including visible light, to achieve a spectral emission of a desired color and luminance for providing a desired stimulus to an image recording medium, e.g. a still or motion camera. It will be appreciated by persons skilled in the art that there are multiple commercially available dyes or coatings that may provide suitable illumination. Some of these dyes are disclosed in U.S. Pat. Nos. 5,893,413 and 6,211,941 (Erland). This coating may facilitate uniform transmission of the desired light from the background surface, thereby minimizing “bright spots”.

In the preferred embodiment, the material 110 of the chroma-key screen is comprised of a foam material 111. The foam material may be an open cell foam such as Chromakey Green Veltex, manufactured by Velcro Industries B.V. Corporation Netherlands. (Veltex and Velcro are registered trademarks of Velcro Industries.) The front surface 114 may be additionally coated 112 with a commercially available coatings.

Referring again to FIG. 1, it will be appreciated that the surfaces of the top 150, bottom 120, sides 140 and back 130 of the enclosure may be coated or made of a material that reflects the light or a selected spectrum of light from the lighting devices 600. In another embodiment (not shown), the components of the structure or other components may absorb the light or the portion of the light spectrum emitted or transmitted from the back screen material. These can be outer subcomponent layers.

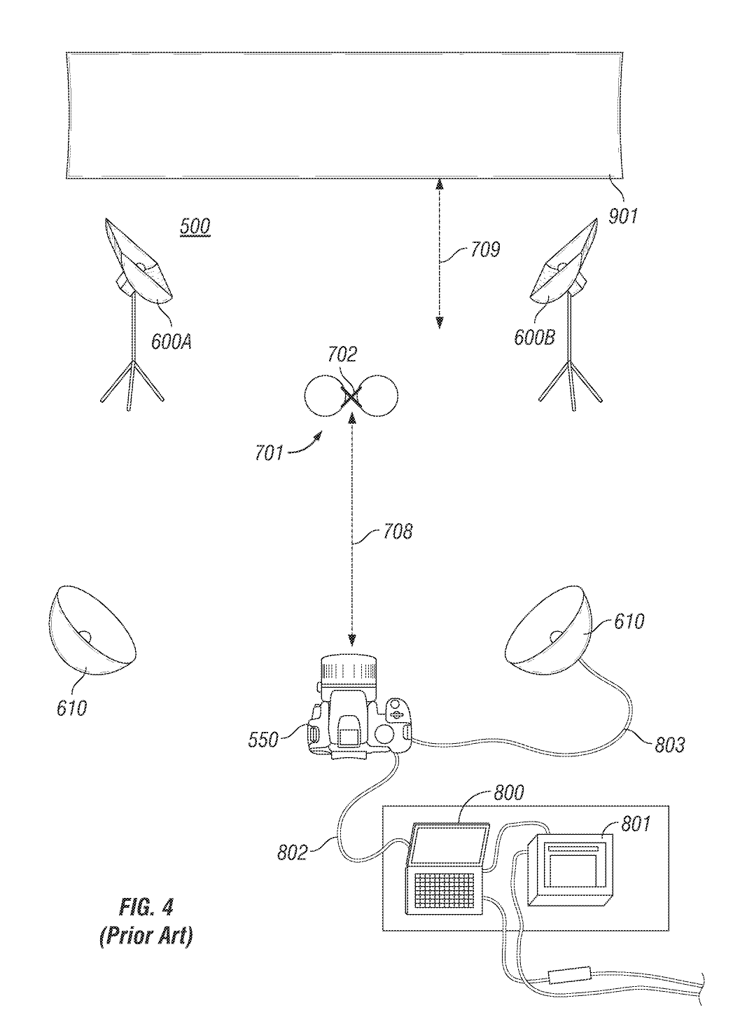

FIG. 4 illustrates a prior art arrangement utilizing at least two sets of lights 600A and 610 positioned in front of the background screen 901. The photo subjects 701 are in the foreground 702 and, in this case, standing on the floor 500. The photo subjects are approximately 5 feet 709 in front of the background. The camera 550 is approximately 6 to 8 feet 708 in front of the objects. The total space between the camera and the background is in excess of 10 feet. One set of lights 610 is used to light the foreground area 700. A separate set of lights 600A-600B is used to light the background. It will be appreciated that without this second set of lights 600A-600B, the photo subjects standing between the first light set 610 and the background will cast shadows on the background, thereby creating a non-uniform background image to the camera 550.

FIG. 4 also illustrates the invention as used in conjunction with ancillary equipment for one type of chroma-key photography. Illustrated are the CPU 800, photo printer 801, electric communication wire between the camera and CPU and a flash synchronization lighting cable to at least one set of lights 610. The CPU may operate the software for subtraction of the chroma-key background color, e.g., the green or blue color, and substitution of a different background image for a composite photo.

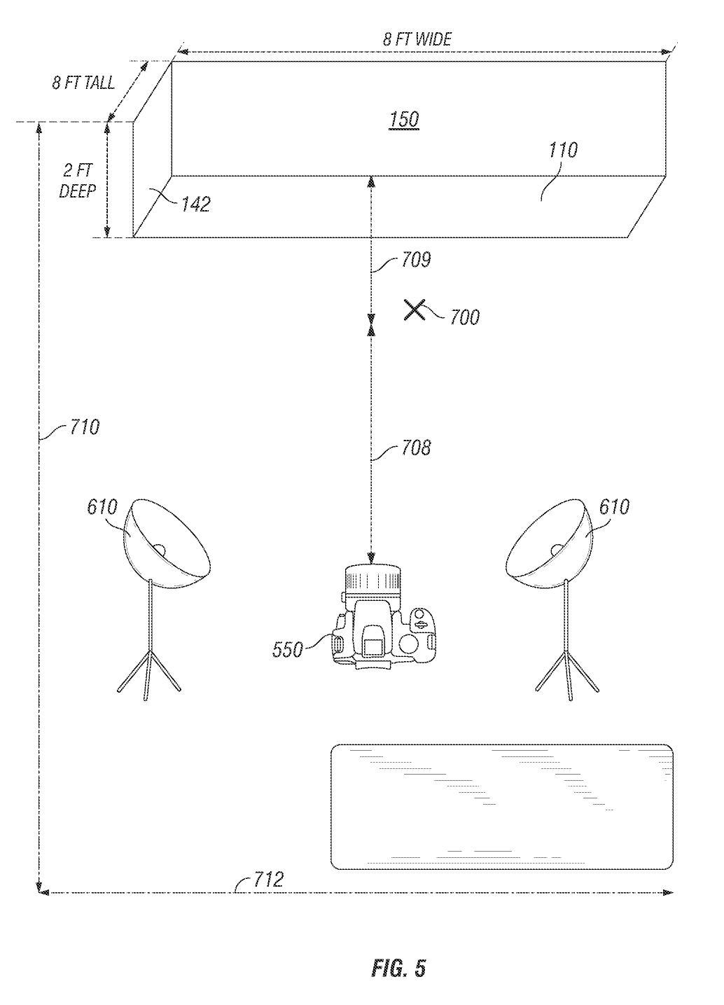

FIG. 5 illustrates the preferred embodiment of the present inventions wherein a single set of lights 610 is between the camera, the foreground “X” and the back-lighted screen 110. It will be appreciated that the structure 100 contains light sources (not shown). The distance between the camera 550 and photo subjects (not shown) can now be reduced to approximately 5 feet, thereby creating greater flexibility, i.e., the photo subject can stand within one foot 709 in front of the chroma-key screen 110 with the camera being 5 feet 708 from the subject. The total area occupied, including ancillary equipment, is approximately 10 ft by 8 ft.

It will be appreciated that the screen material and/or enclosure may be held by a support structure or frame. The support structure can be comprised of attachable/detachable components and subcomponent that are relatively small and lightweight. The screen material, in the preferred embodiment, is also a light weight and foldable or compressible material. The enclosure structure is therefore portable. The support structure holds the background screen, lighting device(s) back, side, top or bottom enclosure panels. In the preferred embodiment, the support components are comprised of subcomponents that can be assembled and un-assembled and are comprised of a plurality of smaller subcomponents. The “collapsible” nature of the enclosure, screen and supports facilitates the flexible use of the device and storage and transportability of the device.

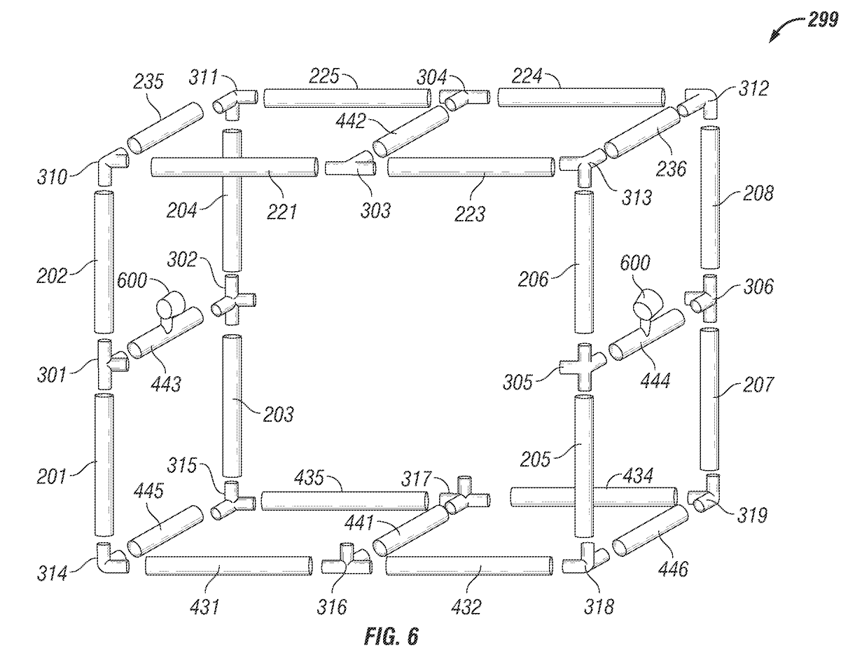

FIG. 6 illustrates a variation of the present invention. The back lighted screen (not shown) is typically 8 ft high and 8 ft wide. The back lighted screen, enclosure sides, back and top are supported by a support frame 299 that is comprised of a plurality of support components. The back lighted screen is held by a set of support components 201, 202, 205, 206, 221, 223 that are each approximately 4 ft in length and have a Velcro (hook or loop) covering (not shown) compatible with a counter part (hook or loop) material on the edge of the screen material. The bottom support structure 431, 432 is also of two 4 ft sections that are not covered with a hook and loop mechanism for attachment to the screen. The support structure also has a counter part back frame comprised of subcomponents 203, 204, 207, 208, 224, & 225. These subcomponents may also be covered with a hook and loop attachment (Velcro) mechanism and to which the back enclosure surface (not shown) is attached. The back frame is attached to the front support frame at the two top corners by hook and loop covered subcomponents 235, 236 that are approximately 2 ft in length. A side panel (not shown) is attached with hook and loop attachments to a top subcomponent 235 or 236 and a set of side subcomponents 201, 202, 203, 204 or 205, 206, 207, 208, each forming the two end sides.

In the preferred embodiment as now practiced, a 2 ft space of the structure 299 screen back surface and the enclosure back side has been found to be adequate for the uniform lighting of the back surface of the background screen (not shown) by one or more light sources 600 such as Photo moonlights of at least 250 Watt Seconds. It will be appreciated that if the screen subject of the invention is used in conjunction with motion photography, a continuous light source would be used. In the preferred embodiment, the front and back support structures are also joined by additional subcomponents at the bottom corners 445, 446 and at each mid point 441, 442, 443, 444. It has been found unnecessary to use hook and loop attaching materials on these subcomponents. The lighting devices can also be attached to the support components and in the preferred embodiment, the mid point side subcomponents 443, 444 are used. In the preferred embodiment a plurality of 3 pronged 301, 302, 304, 305, 306, 311, 312, 316, 317, 318, 319, 303, 310, and 313 male subcomponent are used to fit into and attach together the support components. In the preferred embodiment, the front and back support structures are also joined by additional subcomponents at the bottom corners 445 446 and at each mid point 441, 442, 443, 444. It has been found unnecessary to use hook and loop attaching materials on these subcomponents. The lighting devices can also be attached to the support components and in the preferred embodiment, the mid point side subcomponents 443, 444 are used. In the preferred embodiment a plurality of 3 and 4-pronged male subcomponent are used to fit into and attach together the support components. In the preferred embodiment illustrated in

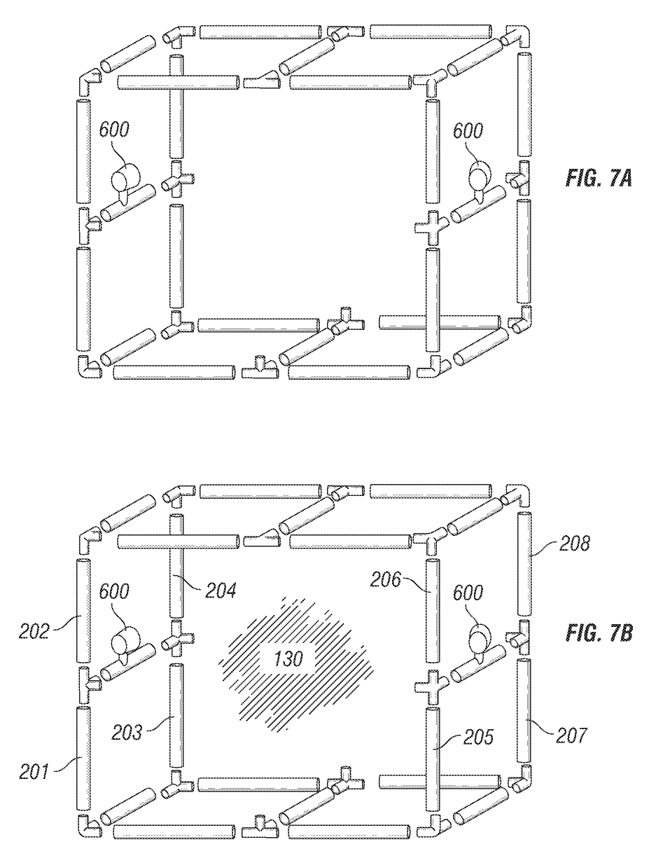

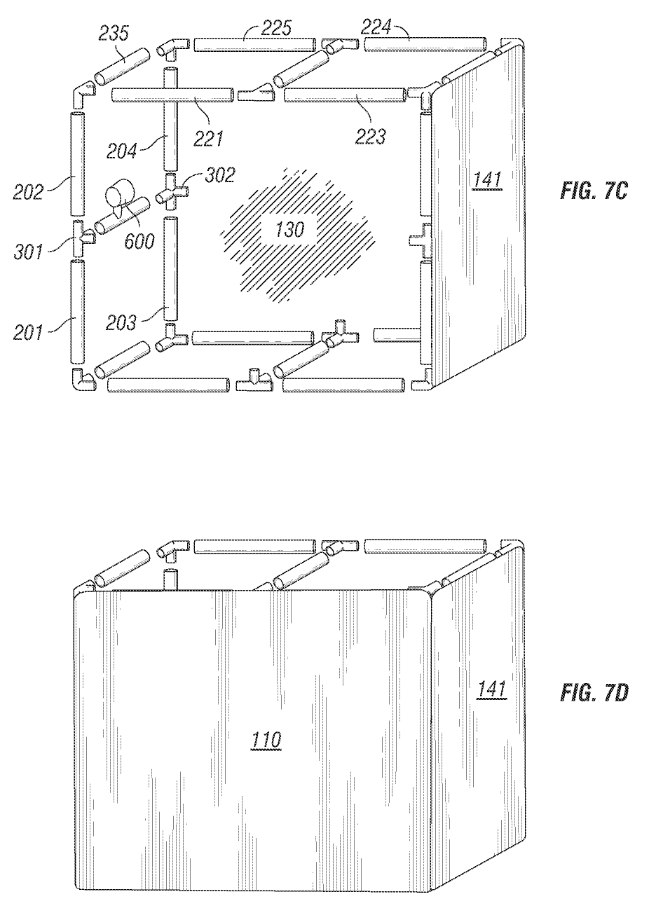

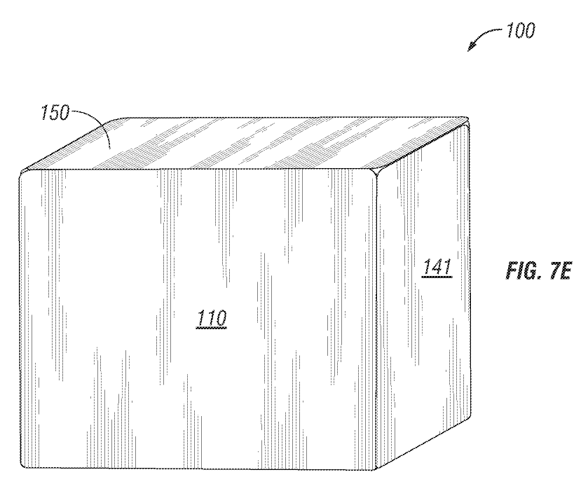

FIGS. 7A and 7B illustrates the subcomponents forming the support structure component 299 and a sequential addition of the back screen enclosure surface 130. The subcomponent of the support structure have the same identifiers as used in the detailed illustration of FIG. 6. FIGS. 7C, 7D and 7E continue the sequential installation of the enclosure sides 141 and the chroma-key screen 110 thereby forming the enclosure structure 100.

FIG. 7C illustrates the support structure component 299 with one side enclosure component 141 attached. FIG. 7D illustrates the addition of the background screen 110 to the structure 299 and FIG. 7E illustrates the completed structure 100. The support structure may also hold lighting device(s), in addition to holding the back-lighted screen and back, top and side enclosure panels. In the one embodiment, the support components are comprised of subcomponents that can be assembled and un-assembled and are comprised of a plurality of smaller subcomponents. The “collapsible” nature of the enclosure, screen and supports facilitates the flexible use of the device and storage and transportability of the device.

While specific embodiments have been illustrated and described, numerous modification are possible without departing from the spirit of the invention, as the scope of protection is only limited by the scope of the accompany claims.

This specification is to be construed as illustrative only and is for the purpose of teaching those skilled in the art the manner of carrying out the invention. It is to be understood that the forms of the invention herein shown and describe are to be taken as the presently preferred embodiments. As already stated, various changes may be made in the shape, size and arrangement of components or adjustments made in the steps of the method without departing from the scope of this invention. For example, equivalent elements may be substituted for those illustrated and described herein and certain features of the invention may be utilized independently of the use of other features, all as would be apparent to one skilled in the art after having the benefit of this description of the invention.

Further modifications and alternative embodiments of this invention will be apparent to those skilled in the art in view of this specification.

What I claim is:

1. A chromo-key screen enclosure comprising:
a. a frame;
b. a first translucent background screen component having a front surface and a back surface; and
c. two side screens, a top screen and a second back screen comprising light reflective surfaces; and
d. one or more light generators within the chroma-key screen enclosure transmitting light onto at least one of second back screen, side screens or top screen.

2. The enclosure of claim 1 further comprising reflected light transmitted to the back surface of the first screen and transfusing a selected color of light from the front surface of the first screen.

3. The device of claim 1 further wherein the second back screen, the side screens or the top screen comprise a coating that absorbs a spectrum of light.

4. The device of claim 1 wherein the color of the first background screen front surface is green.

5. The device of claim 1 wherein the color of the first background screen front surface is blue.

6. The device of claim 1 wherein the first background screen comprises a substantially a non woven material.

7. The device of claim 6 wherein the first background screen includes a foam material.

8. The device of claim 1 further wherein the first chroma-key translucent screen comprises a color absorbing material.

9. The device of claim 1 wherein the light source transmits a green color.

10. The device of claim 1 wherein the light source transmits a blue color.

11. The device of claim 1 wherein the chroma-key screen enclosure restricts color spilling from the light source into a foreground.

12. A method of lighting a back-lit chromo-key screen comprising the steps of
a. placing a first chroma-key background screen having a front surface and a back surface;
b. constructing an enclosure with a floor sitting rectangular frame comprising side screens, a second back screen and a top screen and further comprising attaching the screens to the frame with hook and loop attaching devices;
c. placing separately located two or more lights within the enclosure and directing the light to the second back screen; and
d. reflecting light from the second back screen to the top screen, side screen and to the back of the first translucent chroma-key screen.

13. The method of claim 12 further comprising displaying a flat, featureless and uniform color to an image capturing device.

14. The method of claim 12 further comprising restricting light spillage from the chroma-key enclosure structure to the foreground.

15. The method of claim 12 further comprising supporting the screen, the light source and the enclosure with a multi-piece frame that can be dissembled and assembled.

16. The method of claim 12 further comprising separating the first chroma-key screen and the second back screen by approximately 2 feet.

17. The method of claim 12 further comprising transfusing light through a non woven screen component.

18. A method of chromo-key photography comprising:
a. installing a first chroma-key background screen having a non-woven material component with a front surface and a back surface and capable of transfusing light from the back surface to the front surface;
b. constructing an enclosure behind the first back ground screen and comprising a frame, two side screens, a second background screen and a top screen;
c. installing at least two light generators attached to the frame and lighting the second back screen;
d. transmitting light reflected from the back screen onto the first chroma-key screen back surface, a portion of such light being transfused to the screen front surface and transmitted from the front surface; and
e. displaying a substantially uniform color from the screen front surface;

19. The method of claim 18 further comprising a green chroma-key screen.

20. The method of claim 18 further comprising a blue chroma-key screen.
